(19) United States
(12) Patent Application Publication
(10) Pub. No.: US 2019/0352524 A1
(43) Pub. Date: Nov. 21, 2019

(54) INK JET INK COMPOSITION, RECORDING METHOD, AND RECORDED MATTER

(71) Applicant: Seiko Epson Corporation, Tokyo (JP)

(72) Inventor: Masahiro YATAKE, Shiojiri (JP)

(21) Appl. No.: 16/482,863

(22) PCT Filed: Jan. 15, 2018
(86) PCT No.: PCT/JP2018/000789

§ 371 Date: Aug. 1, 2019

(30) Foreign Application Priority Data
Feb. 2, 2017 (JP) 2017-017493

(51) Int. Cl. C09D 11/322; C09D 11/102; C09D 11/033; C09D 11/037; B41M 5/00; B41M 5/50

(52) U.S. Cl. CPC C09D 11/322; C09D 11/102; B41M 5/502; C09D 11/037; B41M 5/0023; C09D 11/033

(57) ABSTRACT

An ink jet ink composition is provided that is capable of causing an image excellent in scratch resistance to be recorded while obtaining sufficient fixability to a recording medium. The ink jet ink composition contains a urethane resin as a fixing resin, in which a solidified matter of the ink jet ink composition has a Young's modulus at 23° C. of 5 MPa or more and 30 MPa or less.

### BACKGROUND

### Technical Field

The present invention relates to an ink jet ink composition, a recording method, and a recorded matter.

### Related Art

An ink jet recording method is also used for printing business texts including characters, charts, etc. using plain paper or the like as a recording medium. In recent years, the ink jet recording method has been employed in such applications more frequently. In such applications, color developing properties and robustness (abrasiveness, light resistance, ozone gas resistance, water resistance or the like) are required, so that an ink using a pigment as a coloring material is often used.

In general, ink using a pigment has higher color developing properties of a printed matter as compared with an ink using a dye as a coloring material, of which a factor is considered to be that a pigment component is likely to be localized on a surface of the recording medium. In other words, it is considered that, while the dye penetrates to the inside of the recording medium, the pigment is easily aggregated in a process of the ink attached to the recording medium, or due to evaporation or permeation of a vehicle component which occurs after attachment.

Meanwhile, the ink using a pigment has a problem that the scratch resistance of the printed matter is low, because the pigment that is a coloring material easily remains near the surface of the recording medium. It has been proposed that a resin is added to the ink in order to improve the scratch resistance and the like of the printed matter recorded with the ink using a pigment. For example, Japanese Unexamined Patent Application Publication No. 2008-024770 discloses an ink jet ink containing a stimulus-responsive polymer that changes in viscoelasticity. Further, Japanese Unexamined Patent Application Publication No. 2013-112701 proposes a pigment ink jet ink composition obtained by blending a resin exhibiting specific physical properties (elongation at break, and elastic modulus). Furthermore, improvement of the recording medium is also attempted. For example, Japanese Unexamined Patent Application Publication No. 2011-126018 discloses that a specific resin is blended into the recording medium.

An ink jet ink composition has also been attempted to be applied to a non-absorptive medium (recording medium) to which an ink is poorly adhered, and which is called, for example, a soft packaging film. One approach is to increase an adding amount of a fixing resin added in order to provide sufficient scratch resistance to an image formed on such a medium. However, when the adding amount of the resin is increased, a viscosity of the ink composition is also increased, and the ink composition cannot be employed in the ink jet method. Otherwise, ejection stability may be decreased even if the ink composition can be employed.

On the other hand, in order to enhance the scratch resistance, factors to be considered include selection of a resin to be blended into the ink composition, modification of the resin, alteration of physical properties of the resin, and the like. Apparent indexes have not been found for achieving both the adhesion (fixability) of the ink composition (image) and the scratch resistance, while maintaining excellent basic physical properties (viscosity, ejection stability, etc.) required for the ink jet method.

The inventors have studied and understood that, among various physical property values, Young's modulus of the resin blended into the ink composition can be an index for achieving both good adhesion to the medium to which an ink is poorly adhered and the scratch resistance of the image.

Accordingly, one of objects according to aspects of the present invention is to provide an ink jet ink composition capable of causing an image excellent in scratch resistance to be recorded while obtaining sufficient fixability to a recording medium, and a recording method. Another one of the objects according to the aspects of the present invention is to provide a recorded matter on which an image excellent in fixability and scratch resistance is formed.

### SUMMARY

The present invention is made to solve at least a part of the problems described above, and can be implemented as the following aspects or application examples.

According to an aspect of the present invention, there is provided an ink jet ink composition containing a urethane resin as a fixing resin, in which a solidified matter of the ink jet ink composition has a Young's modulus at 23° C. of 5 MPa or more and 30 MPa or less.

With the ink jet ink composition, it is possible to record an image excellent in scratch resistance while obtaining sufficient fixability to a recording medium. That is, the solidified matter of ink jet ink composition has the Young's modulus at 23° C. of 5 MPa or more and 30 MPa or less, thus fixability and scratch resistance can be improved. When the Young's modulus is 30 MPa or less, a film is appropriately soft and has good cohesion, for example, good tape peelability (fixability). When the Young's modulus is 5 MPa or more, tackiness is less likely to be developed and scratch resistance is good.

In the ink jet ink composition according to the present invention, the urethane resin may have an acid value of 5 mgKOH/g or more and 30 mgKOH/g or less.

With the ink jet ink composition, the fixability to the recording medium can be further improved.

In the ink jet ink composition according to the present invention, the urethane resin may contain a skeleton derived from polycarbonate diol.

With the ink jet ink composition, the scratch resistance of the obtained image can be further improved.

In the ink jet ink composition according to the present invention, the skeleton derived from polycarbonate diol may have a weight average molecular weight of 500 or more and 3,000 or less.

With the ink jet ink composition, it is easy to allow the solidified matter of the ink jet ink composition to have the Young's modulus at 23° C. of 5 MPa or more and 30 MPa or less, and thus the fixability and the scratch resistance can be further improved.

In the ink jet ink composition according to the present invention, the urethane resin may contain a skeleton derived from carboxyl group-containing glycol.

With the ink jet ink composition, at least one of the fixability and the scratch resistance of the obtained image can be improved.

In the ink jet ink composition according to the present invention, the ink jet ink composition may further contain an inorganic pigment.

With the ink jet ink composition, it is possible to form an image excellent in the fixability and the scratch resistance, which is, for example, suitable for a ground image.

In the ink jet ink composition according to the present invention, a recording medium that is an attaching target may have polyolefin as a principle component.

The ink jet ink composition can form an image excellent in the fixability and the scratch resistance even on the recording medium to which an ink is more difficult to adhere, and has the effect of providing good fixability and scratch resistance more remarkably.

In the ink jet ink composition according to the present invention, the ink jet ink composition may further contain water.

In the ink jet ink composition according to the present invention, the solidified matter of the ink jet ink composition may have a Young's modulus at 23° C. of 15 MPa or more and 20 MPa or less.

According to an aspect of the present invention, there is provided a recording method including recording an image on a recording medium by ejecting the ink jet ink composition as stated above from an ink jet recording head.

With the recording method, it is possible to record an image excellent in the scratch resistance while obtaining sufficient fixability to the recording medium.

According to an aspect of the present invention, there is provided a recorded matter including a recording medium; and a first layer formed on the recording medium using an ink jet ink composition containing a urethane resin as a fixing resin, in which a solidified matter of the ink jet ink composition has a Young's modulus at 23° C. of 5 MPa or more and 30 MPa or less.

The recorded matter has an image excellent in the fixability and the scratch resistance formed thereon, and such an image can also be used as, for example, a ground layer.

### DETAILED DESCRIPTION

Hereinafter, some embodiments of the present invention will be described. The embodiments to be described below are examples of the present invention. The present invention is not limited to any of the embodiments to be described, and also includes various modifications performed within a range not changing the spirit of the present invention. Not all the configurations described below are essential configurations of the present invention.

### 1. INK JET INK COMPOSITION

An ink jet ink composition according to this embodiment contains a urethane resin.

### 1.1. Urethane Resin

The ink jet ink composition according to this embodiment contains the urethane resin as a fixing resin.

### 1.1.1. Overview of Urethane Resin

The urethane resin (also referred to as polyurethane) refers to a polymer compound containing a urethane bond in which an isocyanate group and a hydroxyl group have reacted, and includes straight chain and branched ones. Furthermore, the term “urethane resin” also includes those having thermoplasticity regardless of whether or not there is a crosslinked structure, and those having the crosslinked structure and exhibiting no or low Tg or melting point.

An isocyanate group for forming the urethane bond is fed from an isocyanate group-containing compound. Further, a hydroxyl group for forming the urethane bond is fed from a hydroxyl group-containing compound. In order to polymerize, the isocyanate group-containing compound has two or more isocyanate groups, and a compound having two or more hydroxyl groups is selected as the hydroxyl group-containing compound. In the specification, a compound having two or more isocyanate groups may be referred to as polyisocyanate, and a compound having two or more hydroxyl groups may be referred to as polyol. Among these, a compound having two isocyanate groups may be referred to as diisocyanate, and a compound having two hydroxyl groups may be referred to as diol.

A molecular chain between the isocyanate groups of the polyisocyanate and a molecular chain between the hydroxyl groups of the polyol form moieties other than the urethane bond when the polyurethane is formed. In the specification, all or part of the moieties other than the urethane bond when the polyurethane is formed may be referred to as a skeleton. The skeleton may be straight chain or branched.

The urethane resin may contain a bond other than the urethane bond, and examples thereof include a urea bond produced by the reaction of an isocyanate group and an amino group; a urea bond produced by the reaction of a plurality of isocyanate bonds and water; a biuret bond produced by the reaction of a urea bond and an isocyanate group; an alphanate bond produced by the reaction of a urethane bond and an isocyanate group; a uretdione bond produced by the dimerization of isocyanate groups; an isocyanurate bond by the trimerization of isocyanate groups; and the like. These bonds may or may not be proactively produced by adjusting the reaction temperature or the like. Therefore, for example, when polyisocyanates, polyols and polyamines coexist, polyurethane containing a urethane bond and a urea bond can be produced.

Additionally, regarding polyamine, a compound having two or more amino groups is also called polyamine, as the same as in cases of the polyisocyanate and the polyol.

The urethane resin according to this embodiment may have a skeleton derived from polycarbonate diol. That is, the urethane resin according to this embodiment may contain polycarbonate diol in a raw material.

The urethane resin (polyurethane) contained in the ink jet ink composition according to this embodiment is produced from at least polyisocyanate and polyol as raw materials. Besides these, polyamine or the like may be used as the raw material (details will be described later). In addition, all or part of the polyol may be polycarbonate diol.

As used herein, the skeleton of the urethane resin refers to a molecular chain between functional groups. Thus, the urethane resin according to this embodiment has the skeleton derived from molecular chain of the raw materials such as polyisocyanate, polyol, polyamine and the like. The other skeleton is not particularly limited, and is, for example, a substituted or unsubstituted, saturated, unsaturated or aromatic chain, and such a chain may have a carbonate bond, an ester bond, an amide bond, or the like. Further, types and numbers of substituents in such a skeleton are not particularly limited, and an alkyl group, an hydroxyl group, a carboxyl group, an amino group, a sulfonyl group, a phosphonyl group and the like may be contained.

### 1.1.2. Crosslinked Structure of Urethane Resin

The urethane resin may be crosslinked by at least one structure selected from the group consisting of an allophanate structure, a biuret structure, a uretdione structure and an isocyanurate structure.

When the urethane resin is crosslinked by at least one structure selected from the group consisting of an allophanate structure, a biuret structure, a uretdione structure and an isocyanurate structure, polar groups in molecules increase to readily form a strong film.

In addition, a crosslinked moiety becomes a hard segment, a microphase separation structure in which hard segments and soft segments are further separated is formed, and the flexibility can also be improved, whereby further improving the scratch resistance of a recorded matter.

As a method of crosslinking the urethane resin, a trifunctional or higher-functional compound can also be used as a crosslinking agent upon a synthesis of the urethane resin. Examples of the trifunctional or higher-functional compounds capable of being used as the crosslinking agent include trifunctional or higher-functional polyisocyanates, polyols and polyamines. Examples of the trifunctional or higher-functional polyisocyanates include polyisocyanate having an isocyanurate structure, and polyisocyanate having an allophanate or biuret structure. As the polyol, glycerin, trimethylolpropane, pentaerythritol, polyoxypropylene triol or the like can be used. Examples of the trifunctional or higher-functional polyamines include amines having a trifunctional or higher-functional amino group, such as trialcohol amine (for example, triethanolamine, triisopropanolamine and the like), diethylene triamine, tetraethylene pentamine or the like.

Whether the urethane resin is crosslinked or not can be determined based on a gel fraction calculated by calculating a ratio of gel content to sol content using the phenomenon that the urethane resin having a crosslinked structure is not dissolved in a solvent but swells. The gel fraction is an index of a degree of crosslinking measured from solubility of the solidified urethane resin, which tends to be higher as the degree of crosslinking is higher.

### 1.1.3. Raw Materials of Urethane Resin

The urethane resin is a resin polymerized using at least polyisocyanate and polyol. However, the urethane resin used in the ink jet ink composition according to this embodiment may be polymerized using polyamine, and may use polyol, polyamine or the like as a crosslinking agent or a chain extension agent if needed.

### 1.1.3.1. Polyisocyanate

The polyisocyanate is not particularly limited as long as it is a compound containing a bifunctional or higher-functional isocyanate group, and examples thereof include aliphatic polyisocyanate, aromatic polyisocyanate, and alicyclic polyisocyanate.

Examples of the aliphatic polyisocyanate include polyisocyanate having a chain-like structure such as tetramethylene diisocyanate, hexamethylene diisocyanate, dodecamethylene diisocyanate, 2,2,4-trimethylhexamethylene diisocyanate, 2,4,4-trimethylhexamethylene diisocyanate, lysine diisocyanate, 2-methylpentane-1,5-diisocyanate, 3-methyl-1,5-pentane diisocyanate, or the like; isophorone diisocyanate; and the like.

The aromatic polyisocyanate can also be used. Examples thereof include tolylene diisocyanate, xylylene diisocyanate, 4,4′-dibenzyl diisocyanate, 1,3-phenylene diisocyanate, 1,4-phenylene diisocyanate, dialkyl diphenyl methane diisocyanate, tetraalkyldiphenylmethane diisocyanate, α,α,α,α-tetratyl xylylene diisocyanate 2,2′-diphenylmethane diisocyanate, 2,4-diphenylmethane diisocyanate, 4,4′-diphenylmethane diisocyanate, 1,5-naphthylene diisocyanate, and the like. When the aromatic polyisocyanate is used, a blocked alicyclic polyisocyanate in which 80% or more of aromatic rings of the aromatic polyisocyanate is hydrogenated may be used.

Examples of the alicyclic polyisocyanate include hydrogenated 4,4′-dicyclohexylmethane diisocyanate (hydrogenated MDI), methyl cyclohexylene diisocyanate, 1,3-bis(isocyanate methyl) cyclohexane, 1,4-cyclohexane diisocyanate, xylylene diisocyanate, hydrogenated xylylene diisocyanate (hydrogenated XDI), and the like.

By using these polyisocyanates, strength of a film to be formed is enhanced and the scratch resistance is improved. In particular, when the blocked alicyclic polyisocyanate or the alicyclic polyisocyanate stated above are used, the film strength may be further enhanced and the scratch resistance may be further improved. Moreover, several types of these polyisocyanates may be mixed and used.

Moreover, the polyisocyanate may refer to a structure composed of polyisocyanate having two or more molecules. The structure composed of polyisocyanate having two or more molecules is, for example, a uretdione structure or an isocyanurate structure. By selecting such polyisocyanate, the urethane resin has a structure in which molecules are sterically entangled in complex and is in a state where the urethane bonds are dense. Therefore, the urethane resin can be stably dispersed in a water-based ink even though, for example, an acid value is low.

Further, intermittent ejection stability generally decreases as the water is evaporated from a nozzle of an ink jet head. In order to increase the intermittent ejection stability, one of the key points is that the pigment and the resin do not aggregate but maintain a state of being stably dispersed even when the water is evaporated in some amount from the ink composition existed near the nozzle of the ink jet head and then the interaction between the urethane resin and the pigment is enhanced. Since the urethane resin according to this embodiment has a relatively low acid value but a sterically complex entangled structure by containing the structure composed of the polyisocyanate, even when the water is evaporated, repellence caused by electrostatic action or repulsion easily occurs between the urethane resin and the pigment, and a stable dispersed structure is easily obtained.

### 1.1.3.2. Polyol

The urethane resin according to this embodiment contains polyol as the raw material. The polyol is not particularly limited as long as it is a compound having a bifunctional or higher-functional hydroxyl group. Examples of the polyol include polyester polyol, polyether polyol, polycarbonate diol and the like.

Examples of the polyester polyol include acid ester and the like. Examples of an acid component constituting the acid ester include aliphatic dicarboxylic acid such as malonic acid, succinic acid, tartaric acid, oxalic acid, glutaric acid, adipic acid, pimelic acid, suberic acid, azelaic acid, sebacic acid, alkylsuccinic acid, linolenic acid, maleic acid, fumaric acid, mesaconic acid, citraconic acid, itaconic acid, or the like; alicyclic dicarboxylic acid such as phthalic acid, naphthalene dicarboxylic acid, biphenyl dicarboxylic acid, tetrahydrophthalic acid, aromatic hydrogen-added product, or the like; and the like. Anhydrides, salts, alkyl esters, acid halides and the like of these acid components can also be used as the acid component. Moreover, an alcohol component constituting the acid ester is not particularly limited, and can be exemplified by the diol compound stated above.

Examples of the polyether polyol include addition polymers of alkylene oxide and polyols, (poly)alkylene glycol, and the like. Examples of the alkylene oxide include ethylene oxide, propylene oxide, butylene oxide, α-olefin oxide, and the like. Further, as the polyols which are subjected to addition polymerization with the alkylene oxide, those listed as examples of the components constituting the polyester polyol can be listed. As the (poly)alkylene glycol, those listed as examples of the components constituting the polyester polyol can be listed.

Moreover, when using the polyol as a starting material of the urethane resin contained in the ink jet ink composition according to this embodiment, it is more preferable that an acid radical exist in a molecule of the polyol. Examples of the acid radical-containing diol include dimethylol acetic acid, dimethylol propionic acid, dimethylol butanoic acid, dimethylol butyric acid, and the like. Among these, dimethylol propionic acid and dimethylol butanoic acid are more preferable.

Further, when the ink jet ink composition according to this embodiment is a water-based composition, it is preferable to use a substance having both a hydroxyl group and a carboxyl group, such as dimethylol propionic acid, to introduce a carboxylic acid group. The urethane resin polymerized using such components is mainly composed of two types of segments: hard segments and soft segments. The hard segment is composed of polyisocyanate, short chain polyol, polyamine, a crosslinking agent, a chain extension agent and the like, and mainly contributes to the strength of the urethane resin. On the other hand, the soft segment is composed of long chain polyol or the like, and mainly contributes to the flexibility of the resin. The image formed by the urethane resin has high elasticity while achieving strength and flexibility at the same time, since these hard segments and soft segments form a microphase separation structure.

The polycarbonate diol contains two hydroxyl groups and a molecular chain having a carbonate bond.

Examples of the polycarbonate diol capable of being used as all or part of polyethers in this embodiment include polycarbonate diol obtained by reacting carbonate components (such as alkylene carbonate, diaryl carbonate, dialkyl carbonate or the like), phosgene, and aliphatic polyol components; and alkanediol polycarbonate diol such as polyhexamethylene carbonate diol or the like. Using the polycarbonate diol as the starting material in the urethane resin tends to improve heat resistance and hydrolysis resistance of the produced urethane resin.

The polycarbonate diol has two hydroxyl groups in the molecule, and can be obtained by transesterification of a diol compound and carbonate ester. Examples of the diol compound include 1,4-butanediol, 1,3-butanediol, 1,2-butanediol, 1,5-pentanediol, 1,2-pentanediol, 1,6-hexanediol, 1,5-hexanediol, 1,2-hexanediol, 1,7-heptanediol, 1,8-octanediol, 1,2-octanediol, 1,9-nonanediol, 1,10-decanediol, neopentyl glycol, 2-methyl-1,3-propanediol, 2-methyl-1,8-octanediol, 2-isopropyl-1,4-butanediol, 2-ethyl-1,6-hexanediol, 3-methyl-1,5-pentanediol, 2,4-dimethyl-1,5-pentanediol, 2,4-diethyl-1,5-pentanediol, 2-ethyl-1,3-hexanediol, 2-butyl-2-ethyl-1,3-propanediol, 1,4-cyclohexanedimethanol, 1,3-cyclohexanediol, 1,4-cyclohexanediol, and the like. These can be used alone or in combination of two or more.

Examples of the commercially available polycarbonate diols include BENEBiOL series including NL 1010 DB, NL 2010 DB, NL 3010 DB, NL 1010 B, NL 2010 B, NL 3010 B, NL 1050 DB, NL 2050 DB and NL 3050 DB (collectively manufactured by Mitsubishi Chemical Corporation), Duranol series (manufactured by Asahi Kasei Chemicals), Nippolan series (manufactured by Tosoh Corporation), polyhexane diol carbonates (manufactured by Kuraray), Placcel series and CDCD 205 PL (collectively manufactured by Daicel Corporation), ETERNACOLL series (manufactured by Ube Industries), and the like.

Since the urethane resin has the skeleton derived from polycarbonate diol by using the polycarbonate diol as the polyether, the scratch resistance of the obtained image can be further improved.

Moreover, when using the polycarbonate diol as the raw material of the urethane resin, it is preferable that the weight average molecular weight be 500 or more and 3,000 or less. When the weight average molecular weight is 500 or more, the density of the urethane bonds in the urethane resin does not excessively increase, and the rigidity of the molecular chain derived from polycarbonate diol can be suppressed. Consequently, the flexibility of the urethane resin increases and the scratch resistance of the image is improved. Additionally, when the weight average molecular weight of the polycarbonate diol reacting with the polyisocyanate is 3,000 or less, the density of the urethane bonds in urethane resin does not excessively decrease, the extensibility of the molecular chain derived from polycarbonate diol does not excessively increase, and the flexibility of urethane resin is suppressed, whereby the tackiness is less likely to be developed and the scratch resistance is sufficiently obtained. Therefore, since the balance between the strength and the flexibility of the film (image) formed by the urethane resin is improved by setting the weight average molecular weight of the polycarbonate diol to 500 or more and 3,000 or less, the scratch resistance of the recorded image can be improved. Moreover, it is also preferable that the weight average molecular weight of the polycarbonate diol be 1,000 or more and 3,000 or less, and it is also preferable that the weight average molecular weight be 1,500 or more and 3,000 or less.

### 1.1.3.3. Other Starting Materials

### Alkylene Glycol

Furthermore, as the raw material of the urethane resin, alkylene glycol may be used in addition to the polyol. By using the alkylene glycol, the strength of the film (image) formed by the urethane resin may be enhanced, and the scratch resistance may be further improved.

It is considered that, when polyalkylene glycol is used together with the polycarbonate diol, the alkylene glycol with a low molecular weight infiltrates into a three-dimensional network structure of the polycarbonate diol and reacts with isocyanate to form the urethane bond, thereby forming a strengthen film. Examples of alkylene glycol capable of being used include ethylene glycol, diethylene glycol, triethylene glycol, tetraethylene glycol, polyethylene glycol, 1,2-propylene glycol, 1,3-propanediol, tripropylene glycol, polypropylene glycol, (poly)tetramethylene glycol, hexamethylene glycol, tetramethylene glycol, neopentyl glycol, 1,2-butanediol, 1,3-butanediol, 1,4-butanediol, 1,2-pentanediol, 1,5-pentanediol, 1,2-hexanediol, 1,6-hexanediol, 3-methyl-1,5-pentanediol, 1,2-cyclohexanediol, 1,4-cyclohexanediol, 1,4-cyclohexanedimethanol, 4,4-dihydroxyphenylpropane, 4,4-dihydroxyphenylmethane, glycerin, trimethylol ethane, trimethylol propane, 1,2,5-hexanetriol, 1,2,6-hexanetriol, pentaerythritol, trimethylolmelamine, polyoxypropylene triol, dimethyl-1,3-pentanediol, diethyl-1,3-pentanediol, dipropyl-1,3-pentanediol, dibutyl-1,3-pentanediol, 2-butyl-2-ethyl-1,3-propanediol, and the like. An adding amount of these alkylene glycols is preferably 1/10 mol or less of the polycarbonate diol. If the adding amount exceeds 1/10 mol, since the unreacted components of OH of the polycarbonate diol increase, the film strength may not be sufficiently obtained.

### Polyamine

The urethane resin according to this embodiment may contain polyamine as the raw material. The polyamine is not particularly limited as long as it is a compound having a difunctional or higher-functional amino group.

Examples of the polyamine include aliphatic diamine such as ethylene diamine, propylene diamine, 2,2-dimethyl-1,3-propanediamine, 2-methyl-1,5-pentanediamine, trimethyl hexane diamine, 2-butyl-2-ethyl-1,5-pentanediamine, 1,8-octane diamine, 1,9-nonanediamine, 1,10-decanediamine, or the like; diethylene triamine; hexylene diamine; triethylenetetramine; tetraethylenepentamine; isophorone diamine; xylylene diamine; diphenylmethanediamine; hydrogenated diphenylmethanediamine; hydrazine; polyamide polyamine; polyethylene polyimine; 1-amino-3-aminomethyl-3,5,5-trimethylcyclohexane; dicyclohexylmethanediamine; isopropylitin cyclohexyl-4,4′-diamine; 1,4-diaminocyclohexane; 1,3-bisaminomethylcyclohexane; and the like. Additionally, most of the compounds generally used as polyamines have molecular weights equivalent to those of short chain polyols, and basically, those compounds are urea groups or biuret groups which are hard segments of the urethane resin.

Moreover, the polyamine can be used also as a component to react with polyfunctional polyisocyanate, a chain extension agent, a crosslinking agent, and the like. Meanwhile, by reacting an isocyanate group with an amino group, a urea bond is formed. Therefore, when the polyamine is used, the use amount of polyamine can be determined so that a ratio of urea group/urethane group in the urethane resin is a desired ratio, thereby controlling the physical properties of the urethane resin.

Examples of a method of adjusting the ratio of urea group/urethane group in the urethane resin include a method of adjusting the use amount of amino groups of the amine compound (polyamine) while taking into consideration of the equivalent thereof upon synthesizing the urethane resin; a method of adjusting a residual ratio of unreacted isocyanate groups when the urethane resin transforms to water via phase inversion; and the like.

In the method of adjusting the use amount of polyamine upon synthesizing the urethane resin, the amount of urea bond produced by the reaction of polyamine and isocyanate group is controlled. Different amounts of polyamines are used to synthesize multiple types of the urethane resins, and the ratio of urea group/urethane group is calculated. From the molar ratio obtained, a correlation between the use amount of polyamine and the molar ratio of polyamine can be obtained to create a calibration curve, which is used to determine the amount of polyamine required to synthesize the urethane resin with the desired molar ratio. The reason why the calibration curve is created in advance is that the same molar ratio may not be obtained even though the same type of polyamine is used, because a reaction rate may be different if other components are different.

In addition, as the method of adjusting a residual ratio of unreacted isocyanate groups when the urethane resin transforms to water via phase inversion, at first, during the synthesis reaction of the urethane resin, the residual ratio of isocyanate group to the use amount of polyisocyanate is confirmed by a Fourier transform infrared spectrophotometer (FT-IR). The residual ratio of isocyanate groups can be adjusted by varying the reaction time, the use amount of polyisocyanate, and the like.

### Crosslinking Agent and Chain Extension Agent

The urethane resin according to this embodiment may contain a crosslinking agent and/or a chain extension agent.

The crosslinking agent is used during the synthesis of a prepolymer, and the chain extension agent is used when performing the chain extension reaction after the synthesis of the prepolymer. The crosslinking agent and the chain extension agent for use can be appropriately selected from the polyisocyanates, the polyols, the polyamines and the like, stated above, depending on applications such as crosslinking and chain extension.

The chain extension agent is, for example, a compound to be reacted with the isocyanate groups of the polyisocyanate stated above without forming the urethane bond. As a compound which can be used as the chain extension agent, the polyols, the polyamines and the like, stated above, can be listed as examples. Further, as the chain extension agent, substances capable of crosslinking the urethane resin can also be used.

Moreover, as the crosslinking agent, among the polyisocyanates, the polyols and the polyamines stated above, trifunctional or higher-functional substances can be listed as examples.

### Others

In addition, as the raw material of the urethane resin according to this embodiment, polyol, such as polyhydroxypolyacrylate, polyhydroxy polyesteramide, polyhydroxy polyacetal, polyhydroxy polythioether or the like, can be used to the extent that the features related to the invention are not affected.

### 1.1.4. Synthesis and Analysis of Urethane Resin

### Synthesis of Urethane Resin

The urethane resin used in the ink jet ink composition according to this embodiment can be synthesized using a known method as a method of polymerizing a urethane resin. Hereinbelow, examples will be described. The polyisocyanate and a compound (polyol and, if necessary, polyamine, etc.) to be reacted with the polyisocyanate are used for reaction in an amount to increase the number of isocyanate groups to polymerize a prepolymer having isocyanate groups at the molecular ends. At this time, if necessary, an organic solvent having a boiling point of 100° C. or less such as methyl ethyl ketone, acetone, tetrahydrofuran or the like may be used. This method is generally referred to as a prepolymer method.

When using an acid group-containing diol as the raw material, a neutralizing agent is used to neutralize the acid groups of the prepolymer. Examples of the neutralizing agent include organic bases such as N,N-dimethyl ethanolamine, N,N-diethylethanolamine, diethanolamine, triethanolamine, triisopropanolamine, trimethylamine, triethylamine or the like; inorganic bases such as sodium hydroxide, potassium hydroxide, ammonia or the like; and the like. The dispersion stability of urethane resin is improved by preferably using the neutralizing agent containing an alkali metal such as sodium hydroxide, potassium hydroxide or the like. These neutralizing agents are used in an amount of preferably 0.5 to 1.0 mol, and more preferably 0.8 to 1.0 mol per 1 mol of acid groups in the prepolymer, whereby the viscosity is less likely to increase and workability is improved.

Thereafter, the prepolymer is added to liquid containing the chain extension agent and/or the crosslinking agent to carry out the chain extension reaction and the crosslinking reaction. Subsequently, when an organic solvent is used, the organic solvent is removed using an evaporator or the like to obtain a dispersion of the urethane resin.

As a catalyst used for the polymerization reaction of a urethane resin, a titanium catalyst, an aluminum catalyst, a zirconium catalyst, an antimony catalyst, a germanium catalyst, a bismuth catalyst and a metal complex catalyst are preferable. Particularly preferred titanium catalysts are tetraalkyl titanates such as tetrabutyl titanate, tetramethyl titanate or the like, and oxalate metal salts such as titanium potassium oxalate or the like.

The other catalysts are not particularly limited as long as they are known catalysts, and tin compounds such as dibutyltin oxide, dibutyltin dilaurate or the like may be listed as examples. As a non-heavy metal catalyst, it already has been known that acetylacetonate complexes of transition metals such as titanium, iron, copper, zirconium, nickel, cobalt, manganese or the like have a urethanization activity. In recent years, low toxicity catalysts capable of replacing heavy metal catalysts have been desired from awareness of environmental issues, and in particular, high urethanization activity of titanium/zirconium compounds has attracted attention, and new catalysts have been actively developed.

### Analysis of Urethane Resin

A composition of the urethane resin, a structure of the polyisocyanate, and an acid value of the urethane resin can be analyzed by the following respective methods.

First, a method of extracting the urethane resin from the ink containing the urethane resin will be described. When the ink jet ink composition contains a pigment, the organic solvent (acetone, methyl ethyl ketone, etc.) which does not dissolve the pigment but dissolves the urethane resin may be used to extract the urethane resin from the ink jet ink composition. Alternatively, the ink jet ink composition may be separated by ultracentrifugation, and a supernatant may be acid-precipitated with an acid to extract the urethane resin.

### (A) Composition of Urethane Resin

The urethane resin is dissolved in deuterated dimethyl sulfoxide (DMSO-d6) to make a sample. Types of polyisocyanate, polyol, polyamine and the like can be confirmed from a position of a peak obtained by analyzing the sample with proton nuclear magnetic resonance (¹H-NMR) or carbon 13 nuclear magnetic resonance (¹³C-NMR). Furthermore, a composition ratio can also be calculated from a ratio of integrated values of chemical shift peaks of respective components. The types of polyisocyanate, polyol, polyamine and the like can also be confirmed by analyzing the urethane resin with pyrolysis gas chromatography (GC-MS). Further, when the analysis is carried out by carbon 13 nuclear magnetic resonance spectroscopy (¹³C-NMR), a number average molecular weight can be calculated by determining a number of repeating units of the long chain polyol.

### (B) Structure of Polyisocyanate

A structure of the polyisocyanate can be confirmed from an infrared absorption spectrum obtained by analyzing the urethane resin by Fourier transform infrared spectroscopy (FT-IR). The main absorptions are as follows. The allophanate structure has NH stretching vibration absorption at 3300 cm⁻¹, and two C═O stretching vibration absorptions at 1750 to 1710 cm⁻¹ and 1708 to 1653 cm⁻¹. The uretdione structure has C═O stretching vibration absorption at 1780 to 1755 cm⁻¹ and absorption based on a uretdione ring at 1420 to 1400 cm⁻¹. The isocyanurate structure has C═O stretching vibration absorption at 1720 to 1690 cm⁻¹ and absorption based on an isocyanurate ring at 1428 to 1406 cm⁻¹. The biuret structure has C═O stretching vibration absorption at 1720 to 1690 cm⁻¹.

### (C) Acid Value of Urethane Resin

The acid value of the urethane resin can be measured by titration. The acid value is measured using AT610 (trade name) manufactured by Kyoto Electronics Manufacturing Co., Ltd., and calculated by applying the numerical values to the following formula (1).

Acid Value(Mg/g)=(EP1−BL1)×FA1×C1×K1/SIZE (1)

(In the formula, EP1 is a titration volume (mL), BL1 is a blank value (0.0 mL), FA1 is a factor of a titration solution (1.00), C1 is a concentration conversion value (5.611 mg/mL) (1 mL of equivalent amount of 0.1 mol/LKOH potassium hydroxide), K1 is a coefficient (1), and SIZE is a sampling amount (g).)

The acid value can be measured for the urethane resin dissolved in tetrahydrofuran by colloid titration using a potential difference. As a titration reagent at this time, an ethanol solution of sodium hydroxide can be used.

### 1.1.5. Acid Value of Urethane Resin

The acid value of the urethane resin can be measured as described above, and the acid value of the urethane resin according to this embodiment is preferably 5 mgKOH/g or more and 30 mgKOH/g or less. Further, the acid value of the urethane resin is more preferably 7 mgKOH/g or more and 25 mgKOH/g or less, and still more preferably 8 mgKOH/g or more and 20 mgKOH/g or less. When the acid value is 5 mgKOH/g or more, dispersion stability of urethane resin in a water-based ink is good, and clogging does not easily occur even at high temperature. On the other hand, when the acid value is 30 mgKOH/g or less, the urethane resin is less likely to swell with water, and the ink is less likely to be thickened. Furthermore, the water resistance of the recorded matter can be kept good. When the acid value exceeds 30 mgKOH/g, the water resistance of the solidified ink decreases, and when the ink is printed on a film or the like, it may be easily peeled off by being wet with water. Additionally, the viscosity of the ink may be increased, the ejection stability may be decreased, the adding amount may be restricted, and the scratch resistance and the tape peeling performance may be insufficient. Furthermore, when the acid value is less than 5 mgKOH/g, the emulsion may not be able to stably exist in the water-based ink, and may coagulate to produce foreign matters. In particular, when exposed to high temperature or in a state where a gas-liquid interface exists, particles tend to aggregate and to produce foreign matters, and the ejection stability is highly likely not to be obtained in some cases.

The acid value of the urethane resin can be varied, for example, by adjusting the content of the skeleton derived from carboxyl group-containing glycol (acid group-containing polyol such as dimethylol propionic acid or the like). When the ink jet ink composition according to this embodiment is a water-based ink, it is preferable that carboxyl group-containing glycol be used to prepare the urethane resin having a carboxyl group so as to be easily dispersed by water.

### 1.1.6. Content of Urethane Resin

The ink jet ink composition according to this embodiment may contain a plurality of types of the urethane resins as described above. Alternatively, the urethane resin may be added in a form of an emulsion. The total content of the urethane resin in the ink jet ink composition according to this embodiment is, on a mass basis (hereinafter “% by mass” will be simply referred to as “%”) as the solid content, preferably 0.1% or more and 20.0% or less, more preferably 1.0% to 15.0%, and still more preferably 1.0% to 8.0%.

### 1.2. Other Components

### 1.2.1. Pigment

The ink jet ink composition according to this embodiment may contain a pigment, a dye or the like as a coloring material. In the ink jet ink composition according to this embodiment, a pigment is more preferable as the coloring material to be used because the coloring material can be physically fixed on the recording medium by the urethane resin stated above. Such a pigment is attached to the recording medium to form an image (recorded matter).

The pigment is not particularly limited, and any of inorganic pigments and organic pigments can be used. Examples of the pigment include organic pigments such as azo pigments, phthalocyanine pigments, condensed polycyclic pigments, nitro pigment, nitroso pigment, hollow resin particles, polymer particles or the like (brilliant carmine 6B, lake red C, watching red, disazo yellow, hansa yellow, phthalocyanine blue, phthalocyanine green, alkali blue, aniline Black, or the like); and inorganic pigments such as metals (cobalt, iron, chromium, copper, zinc, lead, titanium, vanadium, manganese, nickel and the like), metal oxides and sulfides (titanium oxide, zinc oxide, antimony oxide, zinc sulfide, zirconium oxide and the like), carbon blacks (C.I. Pigment Black 7) (furnace carbon black, lamp black, acetylene black, channel black and the like), ocher, ultramarine, Prussian blue, or the like.

Examples of the carbon black used as a black pigment include No. 2300, No. 900, MCF88, No. 33, No. 40, No. 45, No. 52, MA7, MA8, MA100, No. 2200B, and the like (collectively manufactured by Mitsubishi Chemical Corporation), Raven 5750, Raven 5250, Raven 5000, Raven 3500, Raven 1255, Raven 700, and the like (collectively manufactured by Columbia Carbon Corporation), Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (collectively manufactured by Cabot Corporation), Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, Special Black 4 (collectively manufactured by Degussa Corporation), and the like.

Examples of the white pigment include C.I. Pigment White 1 (basic lead carbonate), 4 (zinc oxide), 5 (mixture of zinc sulfide and barium sulfate), 6 (titanium oxide), 6:1 (titanium oxide containing other metal oxides), 7 (zinc sulfide), 18 (calcium carbonate), 19 (clay), 20 (titanium mica), 21 (barium sulfate), 22 (natural barium sulfate), 23 (gloss white), 24 (alumina white), 25 (plaster), 26 (magnesium oxide/silicon oxide), 27 (silica), 28 (anhydrous calcium silicate), and the like.

Examples of the yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, 180, and the like.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, and C.I. Pigment Violet 19, 23, 32, 33, 36 38, 43, 50, and the like.

Examples of the cyan pigment include C.I. Pigment Blue 1, 2, 3, 15, 15:1, 15:2, 15:3, 15:34, 15:4, 16, 18, 22, 25, 60, 65, 66, and C.I. Vat Blue 4, 60, and the like.

Examples of the pigment other than black, white, yellow, magenta, and cyan include C.I. Pigment Green 7, 10, C.I. Pigment Brown 3, 5, 25, 26, C.I. Pigment Orange 1, 2, 5, 7, 13, 14, 15, 16, 24, 34, 36, 38, 40, 43, 63, and the like.

These pigments listed as examples may be used in combination of plural pigments. The total content of the pigment (solid content) in the ink jet ink composition varies depending on the type of pigment used. From the viewpoint of obtaining good color developing properties, when the total mass of ink jet ink composition is 100% by mass, it is preferably 1 to 30% by mass, and more preferably 2 to 15% by mass.

Additionally, when preparing the ink jet ink composition, a pigment dispersing liquid in which a pigment is dispersed may be prepared beforehand, and the obtained pigment dispersing liquid may be added to the ink jet ink composition. Examples of a method of obtaining such a pigment dispersing liquid include a method of dispersing a self-dispersible pigment in a dispersion medium without using a dispersing agent; a method of dispersing a pigment in a dispersion medium using a polymer dispersing agent (resin dispersing agent); a method of dispersing a surface-treated pigment in a dispersing agent, and the like.

### Resin Dispersing Agent

The resin dispersing agent is not particularly limited, and examples thereof include polyvinyl alcohols, Polyvinyl pyrrolidones, polyacrylic acids, an acrylic acid-acrylonitrile copolymer, a vinyl acetate-acrylic acid ester copolymer, an acrylic acid-acrylic acid ester copolymer, a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, a styrene-maleic acid copolymer, a styrene-anhydrous maleic acid copolymer, a vinyl naphthalene-acrylic acid copolymer, a vinyl naphthalene-maleic acid copolymer, a vinyl acetate-maleic acid ester copolymer, a vinyl acetate-crotonic acid copolymer, a vinyl acetate-acrylic acid copolymer, and the like and salts thereof. Among these, a copolymer of a monomer having a hydrophobic functional group and a monomer having a hydrophilic functional group, and a polymer made of a monomer having a hydrophobic functional group along with a hydrophilic functional group are particularly preferable. In addition, the copolymer can be used in any form of a random copolymer, a block copolymer, an alternating copolymer, and a graft copolymer.

As a pigment dispersion type, it is preferable to use a self-dispersible pigment which can be dispersed without a dispersing agent, or a resin dispersing pigment using a resin different from the urethane resin, such as an acrylic styrene resin or an acrylic resin. This is because, when a dispersion resin is a urethane resin, dispersion is likely to be broken due to the interaction thereof, and in particular, the ink is easily thickened at high temperature.

As the resin dispersing agent, a commercially available product can be used. Specific examples thereof include Joncryl 67 (weight average molecular weight: 12,500, acid value: 213), Joncryl 678 (weight average molecular weight: 8,500, acid value: 215), Joncryl 586 (weight average molecular weight: 4,600, acid value: 108), Joncryl 611 (weight average molecular weight: 8,100, acid value: 53), Joncryl 680 (weight average molecular weight: 4,900, acid value: 215), Joncryl 682 (weight average molecular weight: 1,700, acid value: 238), Joncryl 683 (weight average molecular weight: 8,000, acid value: 160), Joncryl 690 (weight average molecular weight: 16,500, acid value: 240) (hereinabove trade names, collectively manufactured by BASF Japan Ltd.), and the like.

When the pigment is contained in the ink jet ink composition, the adding amount as the solid content of the pigment is, for example, 1% by mass or more and 10% by mass or less, and preferably 2% by mass or more and 8% by mass or less, based on the total amount of the ink jet ink composition.

The adding amount of the pigment shall be dependent on the content of the urethane resin stated above, and is preferably ⅓ times or more and 2 times or less, and more preferably ½ times or more and 1.8 times or less, of the adding amount of the urethane resin. Clogging and intermittent ejection stability can be kept good because sufficient fixability of the pigment can be obtained, and the viscosity of the ink jet ink composition does not increase too much by setting the adding amount to fall within such a range.

When the attaching target of the ink jet ink composition according to this embodiment is a recording medium such as a transparent or translucent film or the like, in a case of using the pigment, if an inorganic pigment (white pigment) is used, a ground layer (a first layer described later) excellent in the fixability and the scratch resistance can be formed, and such a ground layer can form a recorded matter having excellent background shielding property.

### 1.2.2. Water

The ink jet ink composition according to this embodiment may contain water. Examples of the water include water obtained by removing ionic impurities as much as possible, that is, pure water such as ion exchanged water, ultrafiltrated water, reverse osmotic water, distilled water or the like; and ultrapure water. In addition, if water obtained by sterilization by ultraviolet ray emission, hydrogen peroxide addition or the like is used, it is possible to prevent generation of bacteria or fungi in a case where the ink jet ink composition is stored for a long period of time.

The content of water contained in the ink jet ink composition is equal to or more than 30% by mass, preferably equal to or more than 40% by mass, more preferably equal to or more than 45% by mass, and still more preferably equal to or more than 50% by mass, with respect to the total mass of the ink jet ink composition. The term “water in ink jet ink composition” includes, for example, water coming from urethane resin particle dispersing liquid used as the raw material, pigment dispersing liquid, water to be added and the like. By setting the water content to 30% by mass or more, the ink jet ink composition can have a relatively low viscosity. The upper limit of the water content is preferably 90% by mass or less, more preferably 85% by mass or less, and still more preferably 80% by mass or less, based on the total amount of the ink jet ink composition.

The ink jet ink composition according to this embodiment is more preferably a water-based ink containing water. Consequently, the urethane resin is easily dispersed in a form of the emulsion, and the image further excellent in the fixability and the scratch resistance can be easily formed by the ink jet method.

1.2.3. Fixing Resin Other than Urethane Resin

The ink jet ink composition according to this embodiment may contain a fixing resin other than the urethane resin. As such a resin, at least one selected from styrene acrylic resins, acrylic resins, and vinyl chloride-vinyl acetate resins can be listed as examples. These resins can be supplied in a form of the emulsion. When the resin is supplied as the emulsion, D50 of the resin particles is preferably 30 nm or more and 300 nm or less, and more preferably 40 nm or more and 100 nm or less. When D50 falls within such a range, the resin emulsion particles can be uniformly dispersed in treatment liquid. Moreover, the scratch resistance of the recorded matter will be further improved.

Examples of the commercially available resin emulsion include MicroGel E-1002, E-5002 (trade names, collectively manufactured by Nippon Paint; styrene-acrylic resin emulsions), Voncoat 4001 (trade name, manufactured by DIC; acrylic resin emulsion), Voncoat 5454 (trade name, manufactured by DIC; styrene-acrylic resin emulsion), Polysol AM-710 (Tg: 56° C.), AM-920 (Tg: −20° C.), AM-2300 (Tg: 67° C.), AP-4735 (Tg: 21° C.), AT-860 (Tg: 60° C.), PSASE-4210E (Tg: −50° C.) (acrylic resin emulsions), Polysol AP-7020 (Tg: 85° C.) (styrene-acrylic resin emulsion), Polysol SH-502 (Tg: 30° C.; vinyl acetate resin emulsion), Polysol AD-13 (Tg: 18° C.), AD-(Tg: 15° C.), AD-10 (Tg: 8° C.), AD-96 (Tg: −4° C.), AD-17 (Tg: −10° C.), AD-70 (Tg: −25° C.) (ethylene-vinyl acetate resin emulsions), Polysol PSASE-6010 (Tg: −50° C.) (ethylene-vinyl acetate resin emulsion) (trade names, collectively manufactured by Showa Denko KK), Polysol SAE 1014 (trade name, manufactured by Nippon Zeon Co., Ltd.; styrene-acrylic resin emulsion), Saivinol SK-200 (trade name, manufactured by Saiden Chemical Co., Ltd.; acrylic resin emulsion), AE-120A (trade name, manufactured by JSR; acrylic resin emulsion, Tg: −10° C.), AE 373 D (trade name, manufactured by E-TEC Co., Ltd.; carboxy modified styrene-acrylic resin emulsion), Seikadyne 1900W (trade name, manufactured by Dainichiseika Color & Chemicals Mfg. Co., Ltd.; ethylene-vinyl acetate resin emulsion), Vinyblan 2682 (acrylic resin emulsion, Tg: −30° C.), Vinyblan 2886 (vinyl acetate-acrylic resin emulsion, Tg: 0° C.), Vinyblan 5202 (acetic acid acrylic resin emulsion, Tg: 30° C.) (trade names, collectively manufactured by Nisshin Chemical Industry Co., Ltd.), Elitel KA-5071 S (Tg: 67° C.), KT-8803 (Tg: 61° C.), KT-9204 (Tg: 19° C.), KT-8701 (Tg: 13° C.), KT-8904 (Tg: 10° C.), KT-0507 (Tg: −27° C.) (trade names, collectively manufactured by Unitika; polyester resin emulsions), Hi-Tec SN-2002 (trade name, manufactured by Toho Chemical Co., Ltd.; polyester resin emulsion, Tg: 76° C.), MOVINYL 966A, MOVINYL 7320 (collectively manufactured by Nippon Synthetic Chemical Co., Ltd.), Joncryl 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, 7610 (collectively manufactured by BASF Ltd.), NK Binder R-5HN (manufactured by Shin-Nakamura Chemical Co., Ltd.), and the like.

In a case where a resin other than urethane resin is blended, the solid content is set preferably to 1 to 20% by mass, and more preferably 3 to 15% by mass, when the total mass of the ink jet ink composition is 100% by mass. When the solid content of the resin emulsion is falls within the range stated above, the robustness (scratch resistance) of the image is further improved. Additionally, the ink jet ink composition has further improved long-term stability (dispersion stability).

### 1.2.4. Water-Soluble Organic Solvent

The ink jet ink composition according to this embodiment may contain a water-soluble organic solvent. By containing the water-soluble organic solvent, it is possible to effectively suppress the evaporation of water from a recording head after being left for a long time, while enhancing the ejection stability of the ink jet ink composition in the ink jet method.

Examples of the water-soluble organic solvent include a polyol compound, glycol ether, a betaine compound, and the like.

Examples of the polyol compound include a polyol compound that may have 2 to 6 carbon atoms in a molecule and may have one ether bond in a molecule (preferably a diol compound), and the like. Specific examples thereof include glycols such as diethylene glycol, triethylene glycol, polyethylene glycol, propylene glycol, dipropylene glycol, tripropylene glycol, polypropylene glycol, polyoxyethylene polyoxypropylene glycol, methyl triglycol (triethylene glycol monomethyl ether), butyl triglycol (triethylene glycol monobutyl ether), butyl diglycol (diethylene glycol monobutyl ether), dipropylene glycol monopropyl ether, glycerin, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,3-propanediol, 1,2-butanediol, 1,2-pentanediol, 1,4-butanediol, 1,5-pentanediol, 1,6-hexanediol, 2-methyl-2,4-pentanediol, 3-methyl-1,5-pentanediol, or the like; and the like.

Examples of glycol ether preferably include monoalkyl ether of glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples thereof more preferably include triethylene glycol monomethyl ether, triethylene glycol monobutyl ether, dipropylene glycol monopropyl ether, and the like.

The betaine compound is a compound (intramolecular salt) having a positive charge and a negative charge at non-adjacent positions in the same molecule and having no charge as a whole molecule, in which a dissociable hydrogen atom is not bonded to an atom having a positive charge.

A preferable betaine compound is an N-alkyl substitute of amino acid, and a more preferable betaine compound is an N-trialkyl substitute of amino acid. Examples of the betaine compound include trimethyl glycine (referred to as “glycine betaine”), γ-butyrobetaine, homarine, trigonelline, carnitine, homoserine betaine, valine betaine, lysin betaine, ornithine betaine, alanine betaine, stachydrine, betaine glutamate, and the like. Preferred examples thereof include trimethyl glycine and the like.

In addition, as the water-soluble organic solvent, a pyrrolidone derivative may be used. Examples of the pyrrolidone derivative include N-methyl-2-pyrrolidone, N-ethyl-2-pyrrolidone, N-vinyl-2-pyrrolidone, 2-pyrrolidone, N-butyl-2-pyrrolidone, 5-methyl-2-pyrrolidone, and the like.

A plurality of types of the water-soluble organic solvents may be used. In addition, the total blending amount of the water-soluble organic solvents is, from the viewpoint of viscosity control of the ink jet ink composition and clogging prevention due to the moisturizing effect, 0.2% by mass or more or 30% by mass or less, preferably 0.4% by mass or more and 20% by mass or less, more preferably 0.5% by mass or more and 15% by mass or less, and still more preferably 0.7% by mass or more and 10% by mass or less in sum, with respect to the total amount of the ink jet ink composition.

### 1.2.5. Surfactant

The ink jet ink composition according to this embodiment may contain a surfactant. As the surfactant, any of nonionic surfactants, anionic surfactants, cationic surfactants, and amphoteric surfactants can be used, and these may be used in combination.

When the surfactants are blended into the ink jet ink composition, the amount of the surfactants is 0.01% by mass or more and 3% by mass or less, preferably 0.05% by mass or more and 2% by mass or less, more preferably 0.1% by mass or more and 1% by mass or less, and particularly preferably 0.2% by mass or more and 0.5% by mass or less in sum, with respect to the whole ink jet ink composition.

By containing the surfactant in the ink jet ink composition, the stability when ejecting the ink from the head tends to increase.

### 1.2.6. Chelating Agent

The ink jet ink composition according to this embodiment may contain a chelating agent. The chelating agent has properties of capturing ions. Examples of such a chelating agent include ethylenediamine tetraacetate (EDTA), nitrilotriacetic acid salt of ethylenediamine, hexametaphosphate, pyrophosphate, metaphosphate, and the like.

### 1.2.7. Preservative

The ink jet ink composition according to this embodiment may contain a preservative. By containing the preservative, the growth of molds and bacteria can be suppressed, and the storage stability of the ink composition is improved. Consequently, it is easy for the ink jet ink composition to be used, for example, as a maintenance liquid upon maintenance of a printer with leaving it for a long time without use. Preferred examples of the preservative include Proxel CRL, Proxel BDN, Proxel GXL, Proxel XL-2, Proxel IB, Proxel TN and the like.

### 1.2.8. pH Adjusting Agent

The ink jet ink composition according to this embodiment may contain a pH adjusting agent.

By containing the pH adjusting agent, it is possible, for example, to suppress or facilitate elution of impurities from a member forming an ink flow path, and to adjust cleaning property of the ink jet ink composition. Examples of the pH adjusting agent include morpholines, piperazines, and amino alcohols such as triethanolamine or the like.

### 1.2.9. Other Components

The ink jet ink composition according to this embodiment may further contain various additives such as a moisturizer, a viscosity adjusting agent, a solubilizing aid, an antioxidant, an anti-mold agent, or the like, depending on the necessity.

### 1.2.10. Physical Properties of Ink Jet Ink Composition Young's Modulus of Solidified Matter of Ink Jet Ink Composition

The Young's modulus at 23° C. of a solidified matter of the ink jet ink composition according to this embodiment is 5 MPa or more and 30 MPa or less. The Young's modulus of the solidified matter of the ink jet ink composition is preferably 10 MPa or more and 30 MPa or less, 12 MPa or more and 30 MPa or less, 15 MPa or more and 26 MPa or less, more preferably 15 MPa or more and 25 MPa or less, and still more preferably 15 MPa or more and 20 MPa or less.

As the solidified matter of the ink jet ink composition according to this embodiment has the Young's modulus falling within the range stated above, the scratch resistance and the fixability of the recorded matter can be further improved. The Young's modulus is one of elastic moduli, and appears as an initial elastic modulus of a stress-strain curve, and a slope of a region where Hooke's law is established. It is considered that, in the ink jet ink composition according to this embodiment, at least the fixability is improved because followability of a coating film of the ink is appropriate in a region where a distortion amount of the recording medium is very small after the ink jet ink composition is attached to the recording medium and solidified.

When the Young's modulus is measured, the ink jet ink composition is prepared as a measuring object, and the measurement is carried out using the ink jet ink composition (refer to Examples).

The Young's modulus can be measured by methods according to JIS-C-2151 and ASTM-D-882. Moreover, the Young's modulus may be measured according to the standards of JIS-K-7113, JIS-K-7161, and JIS-K-7127. The Young's modulus is a ratio of stress S to strain a when a material behaves elastically (elastic region), and is represented by a constant E, and E=S/a. That is, it refers to an initial slope of the stress-strain curve. The Young's modulus is a slope at an origin of the stress-strain curve, while an elastic modulus is a value obtained from the slope of the stress-strain curve. The elastic modulus refers to a linear shape or a slope when the stress is specified.

In the measurement of the Young's modulus, the ink jet ink composition to be measured is expanded in an appropriate pad and dried to prepare a 100-μm thickness sheet (solidified matter). According to the specification stated above, a dumbbell-shaped test piece for tensile test is cut out from the sheet by a die-cutting method, and the measurement is carried out.

The test piece is pulled using a tensile tester TENSILONRTG-1250 (manufactured by Shimadzu Corporation) at a strain rate of 200 mm/min. The Young's modulus can be determined from the maximum elastic modulus (represented by the maximum slope of the stress-strain curve) just before the test piece deforms. Additionally, temperature at which the Young's modulus is measured is based on standard atmosphere B (23° C., 50% RH) of IEC60212.

### Surface Tension

The ink jet ink composition according to this embodiment preferably has a surface tension at 20° C. of 20 mN/m or more and 40 mN/m, preferably 20 mN/m or more and 35 mN/m or less, from the viewpoint of the balance between image quality and reliability as the ink for ink jet recording. The surface tension can be measured, for example, by using an automatic surface tension meter CBVP-Z (trade name, manufactured by Kyowa Interface Science Co., Ltd.) to measure the surface tension when a platinum plate is wetted with the ink under the environment of 20° C.

### Viscosity

Further, from the same viewpoint, the viscosity at 20° C. of the ink jet ink composition according to this embodiment is preferably 3 mPa·s or more and 10 mPa·s or less, and more preferably 3 mPa·s ore more and 8 mPa·s or less. The viscosity can be measured under the environment of 20° C. using, for example, a viscoelasticity tester MCR-300 (trade name, manufactured by Pysica).

### 1.3. Effects

The inventors have examined various urethane resins. As a result, the following has been found. A urethane resin having a high degree of crosslinking and high Tg is added to the ink jet ink composition, thereby improving the scratch resistance of the recorded image but decreasing the fixability. However, in a case where the degree of crosslinking and Tg of the urethane resin are lowered in order to improve the fixability, the scratch resistance decreases. Therefore, the fixability and the scratch resistance are in a trade-off relationship regarding the degree of crosslinking and Tg of the urethane resin. The inventors have carried out extensive studies based on the above and found that the Young' modulus of the urethane resin is a key point for improving the scratch resistance while maintaining the high fixability in the urethane resin, whereby it is important that the Young's modulus is 30 MPa or less. Furthermore, it has been also found that the scratch resistance tends to decrease when the Young's modulus of the urethane resin is less than 10 MPa even if it is 30 MPa or less.

Moreover, it has been found that, among the raw materials of the urethane resin, the polyol has large influence on the scratch resistance. In particular, when using the polycarbonate polyol, the scratch resistance is significantly improved.

Moreover, considering the acid value of the urethane resin, it has been found that it is preferable that the acid value be 5 mgKOH/g or more and 30 mgKOH/g or less. Since the urethane resin is mainly composed of polyisocyanate and a component that reacts with the polyisocyanate, when the acid value of the urethane resin is increased to improve the intermittent ejection stability of the ink, a proportion of short chain polyol such as acid group-containing diol increases. Accordingly, the proportion of the long chain polyol, which is a component to be reacted with the polyisocyanate similarly to the short chain polyol, decreases. In this case, the urethane bond increases and the soft segment decreases in the urethane resin, and the flexibility of the urethane resin film is impaired. Increasing its hydrophilicity by increasing the acid value of the urethane resin improves the intermittent ejection stability of the ink, but reduces the scratch resistance and the water resistance of the image. Therefore, instead of increasing the acid value to increase the hydrophilicity of the urethane resin, the inventors have discussed a method that achieves both the intermittent ejection stability of the ink and the scratch resistance of the image by lowering the acid value to some extent. As a result of having examined the various compositions of the urethane resin while setting the acid value of the urethane resin to fall within a range of 5 mgKOH/g or more and 30 mgKOH/g or less, it has been found that it is effective to use the specific polyisocyanate and polyol as moieties formed by polyisocyanate constituting the urethane resin.

Additionally, when the pigment is blended into the ink jet ink composition according to this embodiment, the scratch resistance of the recorded image can be greatly enhanced as long as the pigment is not dispersed by the urethane resin. This is because the interaction between the urethane resin and the pigment is enhanced and, after the ink jet ink composition attaches to the recording medium, a liquid component and the urethane resin move simultaneously, whereby the urethane resin is likely to exist in the vicinity of the pigment.

With the ink jet ink composition according to this embodiment, it is possible to cause an image excellent in the scratch resistance to be recorded while obtaining sufficient fixability to the recording medium. That is, the Young's modulus at 23° C. of the solidified matter of ink jet ink composition is 5 MPa or more and 30 MPa or less, thus the fixability and the scratch resistance can be improved. When the Young's modulus is 30 MPa or less, a film is appropriately soft and has the good cohesion, for example, good tape peelability (fixability). When the Young's modulus is 5 MPa or more, the tackiness is less likely to be developed and the scratch resistance is good.

### 2. INK JET INK SET

An ink jet ink set according to this embodiment includes the ink jet ink composition described above. According to such an ink jet ink set, an image excellent in the scratch resistance can be recorded while obtaining sufficient fixability to the recording medium, regardless of a type of the recording medium.

The ink jet ink set may further include the ink jet ink composition according to this embodiment, and may include an ink jet ink composition different from the ink jet ink composition according to this embodiment, in addition to the ink jet ink composition according to this embodiment.

The ink jet ink set according to this embodiment may include, for example, the ink jet ink composition stated above as a first ink jet ink composition, and further include, a second ink jet ink composition of which a solidified matter has the Young's modulus at 23° C. exceeding 30 MPa. According to such an ink jet ink set, for example, when a first layer is formed on the recording medium by the first ink jet ink composition, and a second layer is formed on the first layer by the second ink jet ink composition, the fixability and the scratch resistance of the image formed by laminating the first layer and the second layer can be obtained at the same time.

The Young's modulus of the solidified matter of the second ink jet ink composition refers to the Young's modulus measured as described in the section of the ink jet ink composition.

Furthermore, in the ink jet ink set according to this embodiment, the first ink jet ink composition may contain a white coloring material, and the second ink jet ink composition may contain a non-white coloring material. According to such an ink jet ink set, when a ground layer is formed by the first ink jet ink composition and an image layer is formed by the second ink jet ink composition on the recording medium, an image with a ground can have both the fixability and the scratch resistance of the image.

### 3. RECORDING METHOD

### 3.1. Recording Medium

A recording method according to this embodiment is used for a recording method of recording on a recording medium using an ink jet ink composition. Hereinafter, an example of the recording medium used together with the recording method according to this embodiment will be described.

The recording medium used in the recording method according to this embodiment is not particularly limited, but a low absorptive or non-absorptive recording medium is preferable. The low absorptive or non-absorptive recording medium refers to a recording medium having properties of absorbing no ink or hardly absorbing ink. Quantitatively, the recording medium used in this embodiment refers to a “recording medium having a water absorption amount of 10 mL/m² or less in 30 msec^{1/2} from the start of contact in the Bristow method.” The Bristow method is the most widely used method for measuring the amount of liquid absorbed in a short time, and is adopted by the Japanese Technical Association of the Pulp and Paper Industry (JAPANTAPPI). As for the details of the test method, refer to standard No. 51 “Paper and Board: Liquid absorption Test Method, Bristow Method” of “JAPANTAPPI's Pulp and Paper Test Methods, 2000 Edition.” Examples of the recording media having such non-absorptive properties include a recording media having no ink receiving layer with ink absorbability on a recording surface, and a recording media having a coating layer with little ink absorbability on a recording surface.

The non-absorbent recording medium is not particularly limited, and examples thereof include a plastic film without an ink absorbing layer; a recording medium coated with plastic on a substrate such as paper or the like; a recording medium having a plastic film adhered thereto; and the like. Examples of the plastic include polyvinyl chloride, polyethylene terephthalate, polycarbonate, polystyrene, polyurethane, polyethylene, polypropylene, and the like.

The low absorptive recording medium is not particularly limited, and examples thereof include a coated paper provided with a coating layer for receiving an oil-based ink on a surface. The coated paper is not particularly limited, and examples thereof include printing papers such as art papers, coated papers, matte papers, and the like.

By using the ink jet ink composition according to this embodiment, a predetermined image excellent in the fixability and the scratch resistance can be more easily formed on such a non-ink-absorptive or low-ink-absorptive recording medium.

In the recording method according to this embodiment, it is more preferable that the recording medium that is an attaching target have a polyolefin (polyethylene, polypropylene or the like) as a principle component. Such a recording medium is generally a recording medium to which an ink is poorly adhered, but on which an image excellent in the fixability and the scratch resistance can be formed, thus the effect of obtaining good fixability and scratch resistance is more remarkably demonstrated.

### 3.2. Recording Method

A recording method according to this embodiment uses the ink jet ink set stated above. According to such a recording method, when the ground layer is formed by the first ink jet ink composition and the image layer is formed by the second ink jet ink composition on the recording medium, an image with a ground can have both the fixability and the scratch resistance of the image.

The recording method according to this embodiment is a method of recording an image on a recording medium by ejecting the ink jet ink composition according to this embodiment described above from an ink jet recording head. Examples of the method of ejecting the ink include a method of applying mechanical energy to the ink by the electrostrictive element, and a method of applying thermal energy to the ink. In this embodiment, it is particularly preferable to use the method of applying mechanical energy to the ink by the electrostrictive element.

Furthermore, in the recording method according to this embodiment, the first layer is formed by the first ink jet ink composition on the recording medium, and the second layer is formed by on the first layer by the second ink jet ink composition. According to such a recording method, for example, when the first layer is formed as the ground layer by the first ink jet ink composition on the recording medium, and the second layer is formed as the image layer by the second ink jet ink composition on the first layer, an image with a ground can have both the fixability and the scratch resistance of the image.

Furthermore, when the ground layer (first layer) is formed by ink jet ink composition containing the inorganic pigment and the image layer (second layer) is formed on the ground layer, the ground layer is formed by the ink jet ink composition according to this embodiment and the image layer is formed by the appropriate ink jet ink composition, and thus a recorded matter in which the image is formed on the ground layer (for example, white) is obtained. Moreover, when the recording medium is transparent, by forming the image layer (first layer) by the non-white ink jet ink composition according to this embodiment, and then forming a white layer (second layer) by the appropriate ink jet ink composition containing the inorganic pigment on the image layer, in addition to the embodiment, the recorded matter can be obtained, which is observed that the image layer (first layer) is formed on the ground layer (second layer) (for example, white) as viewed from a non-recording medium side (a side on which the first layer is not formed).

### 4. RECORDED MATTER

The recorded matter according to this embodiment is obtained by the recording method stated above. The image excellent in the fixability and the scratch resistance is formed on such a recorded matter. The recorded matter according to this embodiment includes a recording medium; and a first layer formed on the recording medium using an ink jet ink composition containing a urethane resin as a fixing resin, in which a solidified matter of the ink jet ink composition has a Young's modulus at 23° C. of 5 MPa or more and 30 MPa or less. The recorded matter has an image excellent in the fixability and the scratch resistance formed thereon, and such an image can also be used as, for example, a ground layer.

The recorded matter according to this embodiment may further include a second layer formed on the first layer by an ink jet ink composition of which a solidified matter has the Young's modulus at 23° C. exceeding 30 MPa. In such a recorded matter, the first layer is formed as the ground layer on the recording medium, and a second layer is formed as an image layer on the first layer. That is, an image with a ground is formed so as to have both the fixability and the scratch resistance of the image.

### 5. EXAMPLES AND COMPARATIVE EXAMPLES

Hereinafter, the present invention will be further specifically described referring to Examples and Comparative Examples. However, the present invention can be modified in various ways unless departing from the spirit of the present invention, and is not limited to the following examples. Additionally, the symbol “%” described with numeric values regarding component amount indicates to “% by mass” unless otherwise indicated.

### 5.1. Polymerization of Urethane Resin

The urethane resins were polymerized as follows. The outline of the following descriptions is summarized in Table 1. The Young's modulus (of the solidified matter) of the urethane resin was measured and obtained in the same manner as the measurement of the Young's modulus of solidified matter of the ink jet ink composition, except that 30% by mass aqueous solution of each urethane resin was prepared.

TABLE 1

| | | | | | | Type of |
|---|---|---|---|---|---|---|
| | | | | | | Carboxyl |
| Urethane | Young's | Type of | Polycarbonate | | | Group- |
| Resin | Modulus | Polycarbonate | Molecular | Acid Value | | Containing |
| EM | (MPa) | Diol | Weight | (mgKOH/g) | Type of Isocyanate | Polyol |
| A | 5 | a | 3000 | 10 | 4,4′- | Dimethylol |
| | | | | | Dicyclohexylmethane | propionic acid |
| | | | | | diisocyanate | |
| B | 15 | b | 1500 | 10 | Hydrogenated xylene | Dimethylol |
| | | | | | diisocyanate | propionic acid |
| C | 12 | b | 1500 | 10 | Polyisocyanate A | Dimethylol |
| | | | | | | propionic acid |
| D | 20 | a | 3000 | 10 | Hydrogenated xylene | Dimethylol |
| | | | | | diisocyanate | propionic acid |
| E | 57 | c | 2000 | 10 | Hydrogenated xylene | Dimethylol |
| | | | | | diisocyanate | propionic acid |
| F | 5 | — | — | 10 | Hydrogenated xylene | Dimethylol |
| | | | | | diisocyanate | propionic acid |
| G | 15 | d | 400 | 10 | Hydrogenated xylene | Dimethylol |
| | | | | | diisocyanate | propionic acid |
| H | 15 | e | 3500 | 10 | Hydrogenated xylene | Dimethylol |
| | | | | | diisocyanate | propionic acid |
| I | 3 | a | 3000 | 4 | Hydrogenated xylene | Dimethylol |
| | | | | | diisocyanate | propionic acid |
| | | | | | | (decreased in |
| | | | | | | amount) |
| J | 30 | a | 3000 | 32 | Hydrogenated xylene | Dimethylol |
| | | | | | diisocyanate | propionic acid |
| | | | | | | (increased in |
| | | | | | | amount) |

### Preparation of Urethane Resin Emulsion A (Urethane Resin EMA)

Into a reaction vessel with a stirrer, a reflux condenser and a thermometer inserted, 1500 g of polycarbonate diol a (reaction product of 1,6-hexanediol and dimethyl carbonate; molecular weight: 3000) obtained by the following method, 320 g of 2,2-dimethylol propionic acid (DMPA) and 1347 g of 2-pyrrolidone (boiling point: 245° C.) were charged under a nitrogen stream and heated to 60° C. to dissolve DMPA. 1245 g of 4,4′-dicyclohexylmethane diisocyanate and 2.6 g of a urethanization catalyst XK-614 (manufactured by Kushimoto Chemical Co., Ltd.) were added to the mixture and heated to 90° C. The urethanization reaction was carried out over 5 hours to obtain an isocyanate-terminated urethane prepolymer.

The reaction mixture was cooled to 80° C. 220 g of triethanolamine was added to and mixed with the reaction mixture, of which 4340 g was extracted and added to a mixed solution of 5400 g of water and 22 g of triethanolamine under strong stirring. 1500 g of ice was charged into the resultant mixture, and 42 g of a 35% aqueous solution of 2-methyl-1,5-pentanediamine was added to carry out the chain extension reaction. The solvent was distilled off so that the solid concentration would be 30%, thereby obtaining polycarbonate urethane resin emulsion A (30% of urethane resin component, 64% of water, 6% of 2-pyrrolidone, acid value of 10 mgKOH/g, Young's modulus of 5 MPa).

### Preparation of Urethane Resin Emulsion B (Urethane Resin EMB)

Polycarbonate urethane resin emulsion B (30% of urethane resin component, 64% of water, 6% of 2-pyrrolidone, acid value of 10 mgKOH/g, Young's modulus of 15 MPa) was obtained in the same manner as in the preparation of the polycarbonate urethane resin emulsion A, except that hydrogenated xylylene diisocyanate was used instead of 4,4′-dicyclohexylmethane diisocyanate and polycarbonate diol b was used instead of polycarbonate diol a.

### Preparation of Urethane Resin Emulsion C (Urethane Resin EMC)

Polycarbonate urethane resin emulsion C (30% of urethane resin component, 64% of water, 6% of 2-pyrrolidone, acid value of 10 mgKOH/g, Young's modulus of 12 MPa) was obtained in the same manner as in the preparation of the polycarbonate urethane resin emulsion A, except that polycarbonate A shown below was used instead of 4,4′-dicyclohexylmethane diisocyanate, and polycarbonate diol b was used instead of polycarbonate diol a.

### Preparation of Urethane Resin Emulsion D (Urethane Resin D)

Polycarbonate urethane resin emulsion D (30% of urethane resin component, 64% of water, 6% of 2-pyrrolidone, acid value of 10 mgKOH/g, Young's modulus of 20 MPa) was obtained in the same manner as in the preparation of the polycarbonate urethane resin emulsion A, except that hydrogenated xylylene diisocyanate was used instead of 4,4′-dicyclohexylmethane diisocyanate.

### Preparation of Urethane Resin Emulsion E (Urethane Resin EME)

Polycarbonate urethane resin emulsion E (30% of urethane resin component, 64% of water, 6% of 2-pyrrolidone, acid value of 10 mgKOH/g, Young's modulus of 57 MPa) was obtained in the same manner as in the preparation of the polycarbonate urethane resin emulsion A, except that hydrogenated xylylene diisocyanate was used instead of 4,4′-dicyclohexylmethane diisocyanate and polycarbonate diol c was used instead of polycarbonate diol a.

### Preparation of Urethane Resin Emulsion F (Urethane Resin EMF)

Polycarbonate urethane resin emulsion F (30% of urethane resin component, 64% of water, 6% of 2-pyrrolidone, acid value of 10 mgKOH/g, Young's modulus of 5 MPa) was obtained in the same manner as in the preparation of the polycarbonate urethane resin emulsion A, except that hydrogenated xylylene diisocyanate was used instead of 4,4′-dicyclohexylmethane diisocyanate, and polyoxypropylene glycol (weight average molecular weight: 3000) was used instead of polycarbonate diol a.

### Preparation of Urethane Resin Emulsion G (Urethane Resin EMG)

Polycarbonate urethane resin emulsion G (30% of urethane resin component, 64% of water, 6% of 2-pyrrolidone, acid value of 10 mgKOH/g, Young's modulus of 15 MPa) was obtained in the same manner as in the preparation of the polycarbonate urethane resin emulsion A, except that hydrogenated xylylene diisocyanate was used instead of 4,4′-dicyclohexylmethane diisocyanate, and polycarbonate diol d was used instead of polycarbonate diol a.

### Preparation of Urethane Resin Emulsion H (Urethane Resin EMH)

Polycarbonate urethane resin emulsion H (30% of urethane resin component, 64% of water, 6% of 2-pyrrolidone, acid value of 10 mgKOH/g, Young's modulus of 15 MPa) was obtained in the same manner as in the preparation of the polycarbonate urethane resin emulsion A, except that hydrogenated xylylene diisocyanate was used instead of 4,4′-dicyclohexylmethane diisocyanate, and polycarbonate diol e was used instead of polycarbonate diol a.

### Preparation of Urethane Resin Emulsion I (Urethane Resin EMI)

Polycarbonate urethane resin emulsion I (30% of urethane resin component, 64% of water, 6% of 2-pyrrolidone, acid value of 4 mgKOH/g, Young's modulus of 3 MPa) was obtained in the same manner as in the preparation of the polycarbonate urethane resin emulsion A, except that polycarbonate diol a was used in an amount of 1628 g (instead of 1500 g), and 2,2-dimethylol propionic acid (DMPA) was used in an amount of 128 g (instead of 320 g).

### Preparation of Urethane Resin Emulsion J (Urethane Resin EMJ)

Polycarbonate urethane resin emulsion J (30% of urethane resin component, 64% of water, 6% of 2-pyrrolidone, acid value of 32 mgKOH/g, Young's modulus of 30 MPa) was obtained in the same manner as in the preparation of the polycarbonate urethane resin emulsion A, except that polycarbonate diol a was used in an amount of 976 g (instead of 1500 g), and 2,2-dimethylol propionic acid (DMPA) was used in an amount of 1024 g (instead of 320 g).

### 5.2. Preparation of Raw Material of Urethane Resin Preparation of Polycarbonate Diol a (PCDa)

Into a 5-L glass separable flask equipped with a stirrer, a distillate trap, and a pressure regulator, 615 g of 1,6-hexanediol (1,6-HD), 1015 g of diphenyl carbonate, and 2.6 mL of aqueous solution of magnesium acetate tetrahydrate (concentration: 3.4 g/L, magnesium acetate tetrahydrate: 22 mg) were charged as raw materials, while purged with nitrogen gas. Under stirring, the mixture was heated so that the internal temperature was raised to fall within a range of 150° C. to 160° C., to dissolve the contents. The pressure was lowered to 26 kPa over 2 minutes. The mixture was then reacted for 100 minutes while removing phenol out of the system. Subsequently, the pressure was lowered to 9.0 kPa over 100 minutes and further lowered to 0.6 kPa over 40 minutes to continue the reaction. The temperature was raised to 170° C., and the reaction was carried out for 100 minutes while removing phenol and unreacted dihydroxy compound out of the system, thereby obtaining a composition containing polycarbonate diol a. The weight average molecular weight in terms of styrene was measured using gel permeation chromatography (GPC) of L7100 system, manufactured by Hitachi, Ltd., using THF as the solvent; the weight average molecular weight was 3,000.

### Preparation of Polycarbonate Diol b (PCDb)

A composition containing polycarbonate diol b was obtained in the same manner as in the preparation of the polycarbonate diol a, except that 615 g of 1,6-hexanediol (1,6-HD) was replaced by 315 g of 1,5-pentanediol (1,5-PD) and 300 g of 1,8-octanediol (1,8-0D). The weight average molecular weight in terms of styrene was measured in the same manner; the weight average molecular weight was 1,500.

### Preparation of Polycarbonate Diol c (PCDc)

A composition containing polycarbonate diol c was obtained in the same manner as in the preparation of the polycarbonate diol a, except that 615 g of 1,6-hexanediol (1,6-HD) was replaced by 315 g of 1,6-hexanediol (1,6-HD) and 300 g of hydroquinone. The weight average molecular weight in terms of styrene was measured in the same manner; the weight average molecular weight was 2,000.

### Preparation of Polycarbonate Diol d (PCDd)

A composition containing polycarbonate diol d was obtained in the same manner as in the preparation of the polycarbonate diol a, except that the urethanization catalyst XK-614 (manufactured by Kushimoto Chemical Co., Ltd.) was used in an amount of 4.8 g (instead of 2.6 g) and heated to 95° C. to carry out the urethanization reaction over 5 hours. The weight average molecular weight in terms of styrene was measured in the same manner; the weight average molecular weight was 400.

### Preparation of Polycarbonate Diol e (PCDe)

A composition containing polycarbonate diol e was obtained in the same manner as in the preparation of the polycarbonate diol a, except that the urethanization catalyst XK-614 (manufactured by Kushimoto Chemical Co., Ltd.) was used in an amount of 1.0 g (instead of 2.6 g) and heated to 75° C. to carry out the urethanization reaction over 12 hours. The weight average molecular weight in terms of styrene was measured in the same manner; the weight average molecular weight was 3,500.

### Synthesis of Polyisocyanate A

Into a reactor equipped with a stirrer, a thermometer, a cooler, and a nitrogen gas inlet tube, 186.0 parts of hydrogenated xylylene diisocyanate, 14.0 parts of isopropyl alcohol, and 0.1 parts of dibutyltin oxide were charged under nitrogen atmosphere. The reaction was carried out at temperature of 80° C. for 2 hours to carry out the urethanization, thereby obtaining a reaction solution. 0.01 part of zirconium 2-ethylhexanoate (allophanatization catalyst) was added to the obtained reaction solution. The reaction was carried out at temperature of 110° C. to obtain a reaction solution. Unreacted hydrogenated xylylene diisocyanate was removed by distilling the obtained reaction solution with a thin film distillation apparatus, thereby obtaining polyisocyanate A. The content of isocyanate groups was adjusted to 20.0%.

### 5.3. Preparation Pigment Dispersing Liquid

### Pigment Dispersing Liquid 1

### Black Dispersing Liquid 1

500 g of deionized water and 15 g of carbon black were mixed. The mixture was stirred for 30 minutes using a rocking mill with zirconia beads having a diameter of 0.3 mm, thereby prewetting the pigment. 4485 g of ion exchanged water was added to this mixture and dispersed by a high pressure homogenizer. The average particle size of the pigment at this time was 110 nm. The dispersing liquid was transferred to a high pressure vessel and pressurized at a pressure of 3 MPa, and then a surface of the pigment was subjected to ozone oxidation treatment by introducing ozone water having an ozone concentration of 100 ppm. pH of this dispersing liquid was adjusted to 9.0 using 0.1 mol/L of aqueous sodium hydroxide solution, and then a concentration of the pigment solid content was adjusted, thereby obtaining pigment dispersing liquid 1. The pigment dispersing liquid 1 contained a self-dispersible pigment having a —COONa group bonded to a particle surface, and the pigment content was 30%.

### Pigment Dispersing Liquid 2

### Black Dispersing Liquid 2

500 g of carbon black, 1000 g of a water-soluble resin, and 14000 g of water were mixed to obtain a mixture. As the water-soluble resin, a resin obtained by neutralizing a styrene-acrylic acid copolymer having an acid value of 100 mg KOH/g and a weight average molecular weight of 10,000 with 0.1 mol/L of aqueous sodium hydroxide solution was used. After dispersing this mixture for 1 hour using a rocking mill with zirconia beads having a diameter of 1 mm, impurities were removed by centrifugation, and vacuum filtration was carried out using a microfilter (manufactured by Millipore) with a pore size of 5.0 μm. The concentration of the pigment solid content was then adjusted to obtain pigment dispersing liquid 2 having pH of 9.0. The pigment dispersing liquid 2 contained a pigment dispersed by the water-soluble resin (resin dispersing agent). The pigment content was 30.0%, and the resin content was 15.0%.

### Pigment Dispersing Liquid 3

### Cyan Dispersing Liquid

After a reaction vessel equipped with a stirrer, thermometer, a reflux tube and a dropping funnel was purged with nitrogen, 300 parts by mass of methyl ethyl ketone was charged into the reaction vessel. 40 parts by mass of styrene, 40 parts by mass of methyl methacrylate, 5 parts by mass of lauryl acrylate, 5 parts by mass of lauryl methacrylate, 5 parts by mass of methoxy polyethylene glycol 400 acrylate AM-90G (manufactured by Shin-Nakamura Chemical Co., Ltd.), 5 parts by mass of acrylic acid, 0.2 parts by mass of ammonium persulfate and 0.3 parts by mass of t-dodecyl mercaptan were charged into the dropping funnel and dropped into the reaction vessel over 4 hours, while a polymer dispersing agent was polymerized. Thereafter, methyl ethyl ketone was added to the reaction vessel to prepare 40% by mass solution of the polymer dispersing agent.

For the polymer dispersing agent solution, the weight average molecular weight in terms of styrene was measured using gel permeation chromatography (GPC) of L7100 system, manufactured by Hitachi, Ltd., using THF as the solvent; the weight average molecular weight was 58,000.

Moreover, a value of polydispersity (Mw/Mn) was 3.1.

Furthermore, 40 parts by mass of the polymer dispersing agent solution stated above, 30 parts by mass of Chromofine Blue C.I. Pigment Blue 15:3 (manufactured by Dainichi Seika Kogyo Co., Ltd., trade name; hereinafter also referred to as “PB 15:3”), as a cyan pigment, 100 parts by mass of 0.1 mol/L of aqueous sodium hydroxide solution, and 30 parts by mass of methyl ethyl ketone were mixed, and subjected to 8-pass dispersion treatment by Ultimizer 25005 (trade name, manufactured by of Sugino Machine Co., Ltd.). 300 parts by mass of ion exchanged water was added to the mixture. The whole amount of methyl ethyl ketone and a part of water were distilled off using a rotary evaporator. The mixture was neutralized with 0.1 mol/L of sodium hydroxide, thereby adjusting the mixture to have pH 9. While a volume average particle size of the cyan pigment was measured with a particle size distribution meter, the mixture was dispersed until the volume average particle size reaches 100 nm, and then filtered through a 3-μm membrane filter to obtain pigment dispersing liquid in which the solid content (polymer dispersing agent and pigment) was 20% by mass.

### Pigment Dispersing Liquid 4

### White Dispersing Liquid

A mixture was obtained by mixing 1000 g of titanium oxide (CR-93, manufactured by Ishihara Sangyo Co., Ltd.), 1000 g of a water-soluble resin, and 14000 g of water. As the water-soluble resin, Solsparse 27000 (manufactured by Nippon Lubrizol Co., Ltd.) having an acid value of 100 mg KOH/g and a weight average molecular weight of 27,000, and neutralized with 0.1 mol/L of aqueous sodium hydroxide solution was used. The mixture was stirred for 1 hour using a rocking mill with zirconia beads having a diameter of 0.3 mm, impurities were removed by centrifugation, and vacuum filtration was carried out using a microfilter (manufactured by Millipore) with a pore size of 5.0 The concentration of the pigment solid content was then adjusted to obtain pigment dispersing liquid 4 having pH of 9.0. The pigment dispersing liquid 4 contained a pigment dispersed by the water-soluble resin (resin dispersing agent). The pigment content was 30.0%, and the resin content was 15.0%.

### 5.4. Preparation of Ink Jet Ink Composition

### Examples 1 to 14 and Comparative Examples 1 and 2

After mixing each component shown below and fully stirring, vacuum filtration was carried out using a microfilter (manufactured by Millipore) with a pore size of 5.0 μm, thereby preparing each ink jet ink composition of Examples 1 to 14 and Comparative Examples 1 to 2. The compositions of Examples and Comparative Examples are summarized in Table 2.

Furthermore, a pigment is indicated by the solid content of the pigment contained in the pigment dispersing liquid. As components other than those shown in Table 2, blended are 10% of 2-pyrrolidone (2-P), 5% of 1,2-hexanediol (1,2-HD), 15% of propylene glycol (PG) (20% only when the cyan pigment is used), 5% of dipropylene glycol (DPG), 0.5% of triethanolamine (TEA), and 0.02% of EDTA (ethylenediaminetetraacetic acid disodium salt), balanced with ion exchanged water (the term “balanced with” means an amount with which the total amount of all components of the ink will be 100.0%).

TABLE 2

| | | | | | | | | | | | | | | | | Comparative | |
|---|---|---|---|---|---|---|---|---|---|---|---|---|---|---|---|---|---|
| | | Examples | | | | | | | | | | | | | | Examples | |
| | | 1 | 2 | 3 | 4 | 5 | 6 | 7 | 8 | 9 | 10 | 11 | 12 | 13 | 14 | 1 | 2 |
| Pigment (Pigment | | 5 | — | — | — | 4 | — | — | — | 5 | 5 | — | — | — | — | — | 5 |
| Dispersing Liquid 1) | | | | | | | | | | | | | | | | | |
| Pigment (Pigment | | — | 5 | — | — | — | 4 | — | — | — | — | 5 | 4 | — | — | — | — |
| Dispersing Liquid 2) | | | | | | | | | | | | | | | | | |
| Pigment (Pigment | | — | — | 2 | — | — | — | 2 | — | — | — | — | — | 2 | — | — | — |
| Dispersing Liquid 3) | | | | | | | | | | | | | | | | | |
| Pigment (Pigment | | — | — | — | 5 | — | — | — | 5 | — | — | — | — | — | 5 | 5 | — |
| Dispersing Liquid 4) | | | | | | | | | | | | | | | | | |
| Urethane Resin EMA | | 3 | — | — | — | 3 | — | — | 2 | — | — | — | — | — | — | — | 1 |
| Urethane Resin EMB | | — | 3 | — | — | — | 3 | 1 | — | — | — | — | — | — | — | — | — |
| Urethane Resin EMC | | — | — | 3 | — | — | — | 1 | 2 | — | — | — | — | — | — | — | — |
| Urethane Resin EMD | | — | — | — | 3 | — | — | — | — | — | — | — | — | — | — | 1 | — |
| Urethane Resin EME | | — | — | — | — | 1 | 1 | 1 | 1 | 3 | — | — | — | — | — | 4 | — |
| Urethane Resin EMF | | — | — | — | — | — | — | — | — | — | 3 | — | — | — | — | — | — |
| Urethane Resin EMG | | — | — | — | — | — | — | — | — | — | — | 3 | — | — | — | — | — |
| Urethane Resin EMH | | — | — | — | — | — | — | — | — | — | — | — | 3 | — | — | — | — |
| Urethane Resin EMI | | — | — | — | — | — | — | — | — | — | — | — | — | 4 | — | — | — |
| Urethane Resin EMJ | | — | — | — | — | — | — | — | — | — | — | — | — | — | 3 | — | — |
| Young's Modulus of | | 10 | 15 | 12 | 20 | 18 | 26 | 25 | 16 | 30 | 5 | 15 | 15 | 15 | 30 | 50 | 4 |
| Composition | | | | | | | | | | | | | | | | | |
| Evaluation | 20° Gloss | 62 | 55 | 58 | 50 | 52 | 46 | 48 | 54 | 40 | 23 | 5 | 67 | 56 | 62 | 18 | 60 |
| Results | Scratch | B | A | B | A | A | A | A | A | B | B | A | B | B | B | A | C |
| | Resistance | | | | | | | | | | | | | | | | |
| | Test | | | | | | | | | | | | | | | | |
| | Fixability Test | A | A | A | A | A | B | B | A | B | B | C | A | A | C | D | B |
| | Intermittent | B | A | A | A | A | A | A | A | C | C | C | C | A | C | A | C |
| | Ejection | | | | | | | | | | | | | | | | |
| | Stability Test | | | | | | | | | | | | | | | | |
| | Continuous | A | A | A | A | A | A | A | A | C | C | D | C | C | C | A | C |
| | Printing | | | | | | | | | | | | | | | | |
| | Stability Test | | | | | | | | | | | | | | | | |
| | Clogging | A | A | A | A | A | A | A | A | C | C | B | C | D | C | A | C |
| | Recoverability | | | | | | | | | | | | | | | | |
| | Test | | | | | | | | | | | | | | | | |

### 5.5. Evaluation Methods

Each ink jet ink composition obtained in the manner stated above was filled in an ink cartridge. The ink cartridge was mounted on an ink jet recording apparatus (trade name: PX-G930, manufactured by Seiko Epson Corporation) ejecting the ink from a recording head by the action of energy of a piezo element. In Examples and Comparative Examples, a recording duty is defined as 100% when a solid image is recorded under the condition of applying one ink drop, in which a mass per drop is 28 ng±10%, to a unit area of 1/600 inch× 1/600 inch. The recording conditions were set as: temperature: 23° C., and relative humidity: 55%. In Examples and Comparative Examples, A and B were regarded as acceptable levels, and C and D as unacceptable levels in the evaluation criteria for each evaluation item below. The evaluation results of each test are summarized in Table 2.

### Measurement of Young's Modulus

The measurement of Young's modulus is carried out by a method according to ASTM-D-882. The Young's modulus is a ratio of stress S to strain a, when a material behaves elastically (elastic region), and is represented by a constant E, and E=S/a. That is, it refers to an initial slope of the stress-strain curve.

Each ink jet ink composition obtained above was dried in a pad at 90° C. for 24 hours. After confirming that there was no weight change, a 100-μm thickness sheet was prepared. A dumbbell-shaped test piece for tensile test was made of the sheet by a die-cutting method, and used as an evaluation sample. The test piece was pulled using a tensile tester TENSILONRTG-1250 (manufactured by Shimadzu Corporation) at a strain rate of 200 mm/min. The Young's modulus was determined from the maximum elastic modulus (linear equation of tangent of the maximum slope of the stress-strain curve) just before the test piece deformed. Additionally, temperature at which the Young's modulus was measured was based on standard atmosphere B (23° C., 50% RH) of IEC60212.

### Gloss Evaluation Test

The gloss was evaluated by measuring 20° gloss with MULTIGLOSS 268 (manufactured by Konica Minolta Co., Ltd.).

### Scratch Resistance Test

Based on JISL 08492013, the scratch resistance test was carried out under the conditions of 100 reciprocations with a load of 200 g using a scratch resistance evaluation apparatus AB-301 (manufactured by Tester Industry). The recorded matter was obtained by recording a solid image of 1.0 inch×0.5 inch having a recording duty of 100% on a film (trade name: OPP plain roll, 25-μm thickness, manufactured by Toyobo Co., Ltd.) using the ink jet recording apparatus stated above. The printing was carried out with a platen temperature of 60° C. and a dot density of 1440 dpi×1440 dpi. Ten minutes after and one day after the recording, evaluations were carried out by pressing a gold-plated cotton on the solid image of the recorded matter. A stain of the gold-plated cotton, a stain of a non-recorded portion and a peeling state of a printed portion were visually confirmed, and the scratch resistance was evaluated according to the evaluation criteria shown below. The practically acceptable range of the scratch resistance evaluation is B or more in the following criteria.

A: there was almost no stain on the gold-plated cotton and no stain on the non-recorded portion, and there was almost no peeling of the printed portion;

B: there were little stains on the gold-plated cotton and on the non-recorded portion, and there was little peeling of the printed portion;

C: there were stains on the gold-plated cotton and on the non-recorded portion, and there was some peeling of the printed portion; and

D: there were considerable stains on the gold-plated cotton and on the non-recorded portion, and the printed portion was quite peeled off.

### Fixability Test

Using the same sample as in the scratch resistance test above, Sellotape (registered trademark) CT-1535 (manufactured by Nichiban Co., Ltd.) was pasted on the solid image portion of the recorded matter ten minutes after and one day after recording, respectively. After leaving the samples at room temperature for 10 minutes, peeling of the recorded portion was observed while peeling at a rate of 1 m/s±10%. The practically acceptable range of the fixability evaluation is C or more in the following criteria.

A: peeling area of the printed portion is 0% of the tape-attached portion;

B: peeling area of the printed portion is 0.1% or less of the tape-attached portion;

C: peeling area of the printed portion exceeds 0.1% and is 1% or less, of the tape-attached portion; and

D: peeling area of the printed portion exceeds 1% of the tape-attached portion.

### Intermittent Ejection Stability Test

The printer PX-G930 (manufactured by Seiko Epson Corporation) was partially modified to be a printer capable of printing a film. Using this printer, the ejection stability evaluation at the time of intermittent printing was carried out under the environment of temperature of 40° C. and relative humidity of 20%. First, it was confirmed whether the ink composition was ejected normally from each of all the nozzles or not. Then, the ink jet ink composition was discharged onto A4-size photo paper (photo glossy paper manufactured by Seiko Epson Corporation), a rest time of 2 minutes was set under the environment of temperature of 40% and relative humidity of 20%, and then the ink composition was discharged again onto the A4-size photo paper. Upon the second discharge, positional deviation of the dots between positions of the dots by the first drops deposited on A4-size photo paper and target positions was measured with an optical microscope. The intermittent characteristics were evaluated based on the following evaluation criteria based on the obtained positional deviation of the dots.

A: positional deviation of the dots is 10 μm or less;

B: positional deviation of the dots exceeds 10 μm and is 20 μm or less;

C: positional deviation of the dots exceeds 20 μm and is 30 μm or less; and

D: positional deviation of the dots exceeds 30 μm.

### Continuous Printing Stability Test

The printer PX-G930 (manufactured by Seiko Epson Corporation) was partially modified to be a printer capable of printing a film. An ink cartridge of this printer was filled with the ink composition obtained above. The ink composition was discharged onto A4-size cotton fabric at a resolution of 720 dpi×720 dpi, and dried at 150° C. for 1 minute to prepare a recording sample of a solid pattern. This operation was repeated up to 8 hours under the environment of temperature of 40° C. and relative humidity of 20% to eject the ink composition. A time until the droplets of the ink composition were not stably ejected from the nozzles was measured. The continuous printing stability was evaluated based on the following evaluation criteria based on the obtained times.

A: even after 8 hours from the discharge start, no discharge failure or discharge disturbance was observed;

B: discharge failure or discharge disturbance was observed in 2 hours or more and less than 8 hours from the discharge start;

C: discharge failure or discharge disturbance was observed in 1 hour or more and less than 2 hours from the discharge start; and

D: discharge failure or discharge disturbance was observed within 1 hour from the discharge start.

### Clogging Recoverability Test

Using the printer PX-G930 (manufactured by Seiko Epson Corporation), an ink cartridge of this printer was filled with the ink composition obtained above. It was confirmed that the ink composition was ejected from all the nozzles by printing A4-size OPP paper at a resolution of 720 dpi×720 dpi. Thereafter, the printer was left for 30 days under the environment of temperature of 40° C. and relative humidity of 20%. After leaving, the ink composition was discharged again from all the nozzles, cleaning was repeated until printing quality was equivalent to the initial printing, and the number of cleaning times was measured. The clogging recoverability was evaluated based on the following evaluation criteria based on the number of cleaning times.

A: the ink composition was ejected from all the nozzles in one to three cleaning operations;

B: the ink composition was ejected from all the nozzles in four to six cleaning operations;

C: the ink composition was ejected from all the nozzles in seven or more cleaning operations; and

D: the ink composition was not ejected from any of the nozzles by cleaning only.

### 5.6. Evaluation Results

The evaluation results of the fixability and the scratch resistance of each example, in which the Young's modulus at 23° C. of the solidified matter of the ink jet ink composition is 5 MPa or more and 30 MPa or less, are all very good. Additionally, the ink jet ink compositions of Examples generally provide excellent results in the gloss test and other tests.

On the other hand, in Comparative Example 1 in which the Young's modulus at 23° C. of the solidified matter of the ink jet ink composition exceeds 30 MPa, the fixability is poor. Meanwhile, in Comparative Example 2 in which the Young's modulus at 23° C. of the solidified matter of the ink jet ink composition is less than 5 MPa, the scratch resistance is poor.

Moreover, considering each of Examples, in Examples 2, 4, 5 and 8, each in which the Young's modulus at 23° C. of the solidified matter of the ink jet ink composition is 15 MPa or more and 20 MPa or less, all evaluation results of the fixability, the scratch resistance and others are also particularly good.

In Examples 13 and 14, when the acid value of the urethane resin emulsion is low, the continuous printing stability and the clogging recoverability are likely to be deteriorated. When the acid value is high, the intermittent ejection stability and fixability are likely to be slightly deteriorated.

Based on the result of Example 10, when the skeleton of the urethane resin emulsion is not derived from polycarbonate, although the scratch resistance and the fixability are good, the ejection stability, the printing stability and the clogging recoverabillity tend to be deteriorated.

In an ink set using the Ink 4 of Example 4 as a first ink and the Ink 1 of Comparative Example 1 as a second ink, the printed matter was prepared by the same method as the scratch test, and the scratch resistance and the fixability were evaluated. Both the scratch resistance and the fixability are scored A-level. Therefore, it has been found, that when the ink of the layer in contact with the recording medium is the ink composition according to the present invention, advantageous effects can also be obtained in the ink set.

The present invention is not limited to the embodiments, and various modifications are possible. For example, the present invention includes substantially the same configurations (for example, configurations of which functions, methods, and the results are the same, or configurations of the object and the effect are the same) as the configurations described in the embodiment. In addition, the present invention includes configurations in which non-essential parts of the configuration described in the embodiment are substituted. In addition, the present invention includes configurations that exhibit the same operations and effects of the configuration described in the embodiment, or configurations with which the same object can be achieved. In addition, the present invention includes configurations obtained by adding a known technology to the configuration described in the embodiment.

The entire disclosure of Japanese Patent Application No. 2017-017493 filed on Feb. 2, 2017 is expressly incorporated by reference herein.

1. An ink jet ink composition comprising
a urethane resin as a fixing resin, wherein
a solidified matter of the ink jet ink composition has a Young's modulus at 23° C. of 5 MPa or more and 30 MPa or less.

2. The ink jet ink composition according to claim 1, wherein
the urethane resin has an acid value of 5 mgKOH/g or more and 30 mgKOH/g or less.

3. The ink jet ink composition according to claim 1, wherein
the urethane resin contains a skeleton derived from polycarbonate diol.

4. The ink jet ink composition according to claim 3, wherein
the skeleton derived from polycarbonate diol has a weight average molecular weight of 500 or more and 3,000 or less.

5. The ink jet ink composition according to claim 1, wherein
the urethane resin contains a skeleton derived from carboxyl group-containing glycol.

6. The ink jet ink composition according to claim 1, further comprising
an inorganic pigment.

7. The ink jet ink composition according to claim 1, wherein
a recording medium that is an attaching target has polyolefin as a principle component.

8. The ink jet ink composition according to claim 1, further comprising
water.

9. The ink jet ink composition according to claim 1, wherein
the solidified matter of the ink jet ink composition has a Young's modulus at 23° C. of 15 MPa or more and 20 MPa or less.

10. A recording method comprising
recording an image on a recording medium by ejecting the ink jet ink composition according to claim 1 from an ink jet recording head.

11. A recorded matter comprising:
a recording medium; and
a first layer formed on the recording medium using an ink jet ink composition containing a urethane resin as a fixing resin,
wherein a solidified matter of the ink jet ink composition has a Young's modulus at 23° C. of 5 MPa or more and 30 MPa or less.
